(19) United States
(12) Patent Application Publication
(10) Pub. No.: US 2012/0179376 A1
(43) Pub. Date: Jul. 12, 2012

(54) Methods And Apparatus For Monitoring Complex Flow Fields For Wind Turbine Applications

(75) Inventors: Martin O'Brien, Conifer, CO (US); Loren M. Caldwell, Ft. Collins, CO (US); Phillip E. Acott, Fort Collins, CO (US); Lisa G. Spaeth, Littleton, CO (US)

(73) Assignee: Ophir Corporation

(21) Appl. No.: 13/348,307

(22) Filed: Jan. 11, 2012

Related U.S. Application Data
(60) Provisional application No. 61/431,696, filed on Jan. 11, 2011.

(51) Int. Cl. G06F 19/00; G01W 1/00

(52) U.S. Cl. 702/3

(57) ABSTRACT

A method is provided for generating range-resolved wind data near a wind turbine generator coupled to a control system. The method includes measuring wind flow data in a first long range region at a distance from a rotor plane of the wind turbine generator with a laser radar. The method also includes calculating wind fields in a second short range region and blade-specific wind fields for the at least one rotating blade based upon the measured wind flow data, the second short range region being generally closer to the rotor plane of the wind turbine generator than the first long range region. The method further includes generating range-resolved wind data. A system is also provided for generating range-resolved wind data near a wind turbine generator. A non-transitory computer readable storage medium provides wind classification codes to a control system coupled to a wind turbine generator based upon range-resolved wind fields,

### CROSS-REFERENCE TO RELATED APPLICATIONS

This application claims the benefit of the filing date of U.S. Provisional Patent Application No. 61/431, 696, filed Jan. 11, 2011, entitled “Methods and Apparatus For Monitoring Complex Flow Fields For Wind Turbine Applications”. The entire content of the above application is incorporated herein by reference. U.S. patent application Ser. No. 12/138,163, filed Jun. 12, 2008, and entitled “Optical Air and Data Systems and Methods,” is incorporated herein by reference.

### BACKGROUND

Laser radar (Lidar) has been used on military and commercial aircraft for the purpose of measuring wind hazards and providing optical air data. Lidar is an optical remote sensing technology that measures properties of scattered light to find range and/or other information of a distant target. The range to an object is determined by measuring the time delay between transmission of a laser pulse and detection of the reflected signal.

Like aircraft, wind turbines or wind turbine generators operate within complex, on-coming, flow fields and have a distinct need for advanced detection, classification, measurement, warning and mitigation of wind hazards. The flow fields may vary from highly laminar through highly turbulent, depending on the local weather, time of day, humidity, temperature, lapse rate, turbine location, local terrain, etc. Lidar can be used to quantify these highly variable conditions for use in gust alleviation, and blade pitch and yaw control. Wind hazards applicable to wind turbines include gusts, high wind speed, vertical and horizontal wind shear, nocturnal low level jets, convective activity, microbursts, complex terrain-induced flows, Kelvin Helmholtz instabilities, turbulence, and other similar events.

Wind turbines can rotate about either a horizontal or a vertical axis, with horizontal-axis turbines far more common. Horizontal-axis wind turbines (HAWT) have a rotor shaft and an electrical generator typically located at the top of a tower, and the rotor shaft is typically parallel with the wind during usage. HAWTs achieve high efficiency since their blades move substantially perpendicular to the wind. Since the tower that supports the turbine produces turbulence behind it, the turbine blades are usually positioned upwind of the tower.

FIG. 1 is a simplified diagram of a horizontal-axis wind turbine 100. The HAWTs may include one, two, three, or more rotating symmetrical blades 102, each having a blade axis approximately perpendicular to the horizontal axis of rotation 104. Turbine blades are generally stiff to prevent the blades from being pushed into the tower by high winds. The blades may be caused to bend by the high winds. High wind speed, gusts and turbulence may lead to fatigue failures of the wind turbines. Blade pitch control is a feature of nearly all large modern horizontal-axis wind turbines to permit adjustment of wind-turbine blade loading, generator shaft rotation speed and the generated power as well as protection from damage during high-wind conditions. While operating, a control system for a wind turbine adjusts the blade pitch by rotating each blade about the blade's axis. Furthermore, wind turbines typically require a yaw control mechanism to turn the axis of wind-turbine rotation, blades and nacelle toward the wind. By minimizing a yaw angle that is the misalignment between wind and turbine pointing direction, the power output is maximized and non-symmetrical loads minimized.

Methods and apparatus have been developed to measure, identify, and quantify the air flow fields or wind flow fields ahead of aircraft and wind turbine generators for the purpose of wind hazard detection and mitigation. The flow fields may be monitored by using laser radar hardware. A prior nacelle-mounted wind speed-measurement laser radar (Lidar) measures range-resolved wind speed and direction, but over a very limited spatial area ahead of a turbine (see www.catchthtewindinc.com). Prior Lidar does not sample the entire area that is swept by a rotor or rotating blade of the turbine. Therefore, the wind data is inadequate for the measurement of vertical or horizontal shear occurring across the entire rotor plane of the turbine. The wind flow data are insufficient to enable blade pitch control for enhanced energy capture and the reduction of turbine stress loads over the entire operating wind speed range of modern wind turbines.

Mikkelsen, T. et al, “Lidar Wind Measurements from a Rotating Spinner”, European Wind Energy Conference and Exhibition 2010, Conference Proceedings, European Wind Energy Association, describes wind monitoring Lidar with two conic scanning geometries. However, Mikkelsen accessed the wind fields only at a predetermined, static range. This means that for gust alleviation and blade pitch control algorithms, the wind fields need to be assumed to be “frozen,” i.e. temporal variability remains constant as the wind field approaches the rotors, an assumption which is often referred to Taylor's frozen turbulence assumption.

Development has also been made in blade pitch control algorithms. One publication by Dunne, F., et al, entitled “Combining Standard Feedback Controllers with Feed forward Blade Pitch Control for Load Mitigation in Wind Turbines”, in 48th Aerospace Sciences Conference Proceeding for the American Institute of Aeronautics and Astronautics (AIAA), Inc., 2010, disclosed the combination of conventional feedback control algorithms with measurements of wind fields, such as those provided by Lidar. Dunne also provided models for measured wind data and applies the models to the blade pitch control algorithms by using feed-forward control.

Dunne's modeling approach revealed that greater than a 10% load reduction in critical turbine blade and tower was achieved, when 5 seconds of preview time for feed-forward control was combined with a conventional feedback control on an individually pitched wind turbine without significant loss of generated power. Dunne's modeling approach used a uniformly stepped gust wind model. A fixed-range wind velocity sampling technique from Lidar was used. For example, all Lidar wind measurements were modeled at a fixed range of 90 m (one rotor diameter up-wind). The analysis indicated that an average of the five, Lidar-based, wind measurements provided good performance, assuming the turbine to have independent control for each blade. Dunne monitored the flow field in a fixed attitude and used an average wind measurement without any attempt to quantify the vertical or horizontal shear.

Laks, et al. “Blade Pitch Control with Preview Wind Measurements”, 48th Aerospace Sciences Conference Proceeding for the American Institute of Aeronautics and Astronautics (AIAA), Inc., 24 pp, 2010, describes lidar-derived preview wind measurements for blade pitch control. Laks discloses a mathematical simulation of preview wind measurements, combined with feed-forward blade pitch control algorithms, and the resultant impact on turbine blade loading and power generation. Laks modeled more complex wind fields than Dunne in the presence of atmospheric turbulence.

Laks disclosed one wind sampling method based on fixed, stationary Lidar measurements such as using a nacelle or tower and another wind sampling method based on rotating wind measurements. Laks demonstrated that the vertical wind shear measured with the fixed, stationary Lidar method was significantly different from actual wind fields, while the rotating wind sampling method was more accurate for reporting actual wind conditions that a blade would encounter than the stationary Lidar measurements. The rotating wind sampling method resulted in better blade pitch control than the stationary wind sampling method. Using the rotating wind sampling method, critical blade loads were reduced by more than 20% without significant loss of generated power. However, Laks did not provide information on how to perform rotating wind measurements.

There remains a need for providing measurements with sufficient spatial and temporal scales with low cost hardware. There still remains a need for providing sufficient understanding of the type, severity or structure of the on-coming turbulent flow field or wind hazard.

### SUMMARY

This disclosure advances the art by providing a cost effective method for measuring wind flow data in a long range using a single Lidar mounted on a wind turbine generator and calculating wind flow fields near a rotor plane of a wind turbine generator using a computer system with a processor. The method generates range-resolved wind data in real time for each blade of the wind turbine generator, and also provide classification data and codes to a control system coupled to the wind turbine generator. The methods and system enable the wind turbine generator to provide for blade pitch control and effective gust alleviation, to reduce structural fatigue and damage, and improve reliability of the wind turbine generator, and to enhance energy capture efficiency for the wind turbine generator.

In an embodiment, a method is provided for generating range-resolved wind data near a wind turbine generator coupled to a control system. The method includes measuring wind flow data in a first long range region at a distance from a rotor plane of the wind turbine generator with a laser radar. The method also includes calculating wind fields in a second short range region and blade-specific wind fields for the at least one rotating blade based upon the measured wind flow data, the second short range region being generally closer to the rotor plane of the wind turbine generator than the first long range region. The method further includes generating range-resolved wind data.

In an embodiment, a system is provided for generating range-resolved wind data near a wind turbine generator. The system includes a laser radar mounted on the wind turbine generator for measuring wind fields in a first long range region at a distance from a rotor plane of the wind turbine generator. The system also includes a computer system to receive the wind fields in a first long range region and to generate range-resolved wind data with an algorithm.

In an embodiment, a non-transitory computer readable storage medium is provided for generating range-resolved wind data near a wind turbine generator. The readable storage medium includes executable instructions to calculate wind fields and blade-specific wind fields in a short range region close to a rotor plane of the wind turbine generator based upon wind flow data measured in a long range region at a further distance from the rotor plane of the wind turbine generator. The readable storage medium also includes executable instructions to generate range-resolved wind data.

In an embodiment, a non-transitory computer readable storage medium provides wind classification codes to a control system coupled to a wind turbine generator, comprising executable instructions to generate classification data and codes based upon range-resolved wind fields. The classification data and codes includes one or more of the following:
(1) type and severity of the range-resolved wind fields including horizontal, vertical, blade-wise shear, and blade-to-blade shear data,
(2) loading and/or variability on each blade of the wind turbine generator resulting from the blade-specific wind fields,
(3) rotor torque and/or variability delivered by each blade resulting from the blade-specific wind fields,
(4) severity, arrival time, and spatial characteristics for gusts,
(5) A temporal characteristics of the range-resolved wind fields, the temporal characteristics comprising arrival times for on-coming gusts, hazards or flow variations, and
(6) A spatial characteristics of the range-resolved wind fields, the spatial characteristics comprising wind fields variability as a function of the yaw angle or the position of the blade.

Additional embodiments and features are set forth in the description that follows, and still other embodiments will become apparent to those skilled in the art upon examination of the specification or may be learned by the practice of the invention.

### BRIEF DESCRIPTION OF THE DRAWINGS

Illustrative embodiments of the present invention are described in detail below with reference to the attached drawings.

FIG. 1 is a simplified diagram of a horizontal axis wind turbine generator.

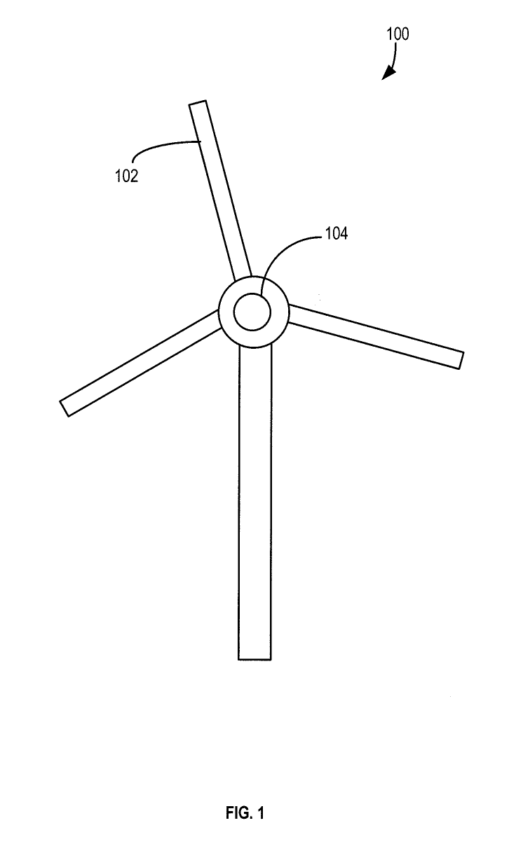

FIG. 2 is a diagram illustrating range-resolved Lidar-measured wind distribution near a wind turbine generator in one embodiment where the Lidar is mounted in the turbine hub, at rotor height.

FIG. 3 is a diagram illustrating blade-specific wind monitoring for preview wind measurements in an embodiment.

FIG. 4 is a simplified diagram of a system including a wind turbine generator, a sensor, and a control system in an embodiment.

FIG. 5 is a flow chart for illustrating steps for generating range-resolved wind data.

FIG. 6 is a flow chart for illustrating steps for providing classification data and code to a control system coupled to a wind turbine generator.

### DETAILED DESCRIPTION

The present disclosure may be understood by reference to the following detailed description, taken in conjunction with the drawings as described below. It is noted that, for purposes of illustrative clarity, certain elements in the drawings may not be drawn to scale. Reference numbers for items that appear multiple times may be omitted for clarity. Where possible, the same reference numbers are used throughout the drawings and the following description to refer to the same or similar parts.

Effective wind hazard monitoring apparatus needs to provide accurate wind data at sufficiently fine spatial scales and sufficiently fast temporal scales to determine the type and severity of wind hazard. A blade-pitch control algorithm needs short range wind data that are at most a few seconds away from the wind turbine generator. In addition, for optimal control the wind turbine generator needs wind information over the entire swept area of the rotor or blade of the wind turbine generator. These regions cannot be monitored with a single fixed-orientation laser radar. Measurements with multiple Lidars would be very expensive.

The methods are disclosed for measuring winds further away from the wind turbine generator and estimating the on-coming winds at a rotor plane where one, two, three or more rotating blades are located in, with a preview time. This estimation is based on wind measurements at longer ranges, including, for example, the horizontal and vertical shear, the spatial structure of the wind field and its temporal characteristics. More specifically, the methods and systems herein disclosed include (1) monitoring oncoming wind conditions and hazards with sufficient speed and spatial resolution; (2) achieving a cost-effective and robust laser radar system design; (3) providing data analysis and data products to be used by wind turbine control systems that may include both hardware components and software for gust alleviation and blade pitch control and yaw control, (4) determining severity of wind events, including horizontal shear, vertical shear, gusts, turbulent flow, low level jets and Kelvin Helmholtz instabilities; (5) classifying the on-coming flow field to enable the wind turbine generator control systems to properly react, in a timely fashion, to the on-coming flow field; (6) calculating data products from the Lidar-measured flow-field; and (7) providing such data analyses and products at sufficient speeds, and at appropriate spatial locations, for effective gust alleviation and blade pitch control and yaw control to reduce structural fatigue and damage, to improve reliability, and to enhance energy capture efficiency for modern wind turbine generators.

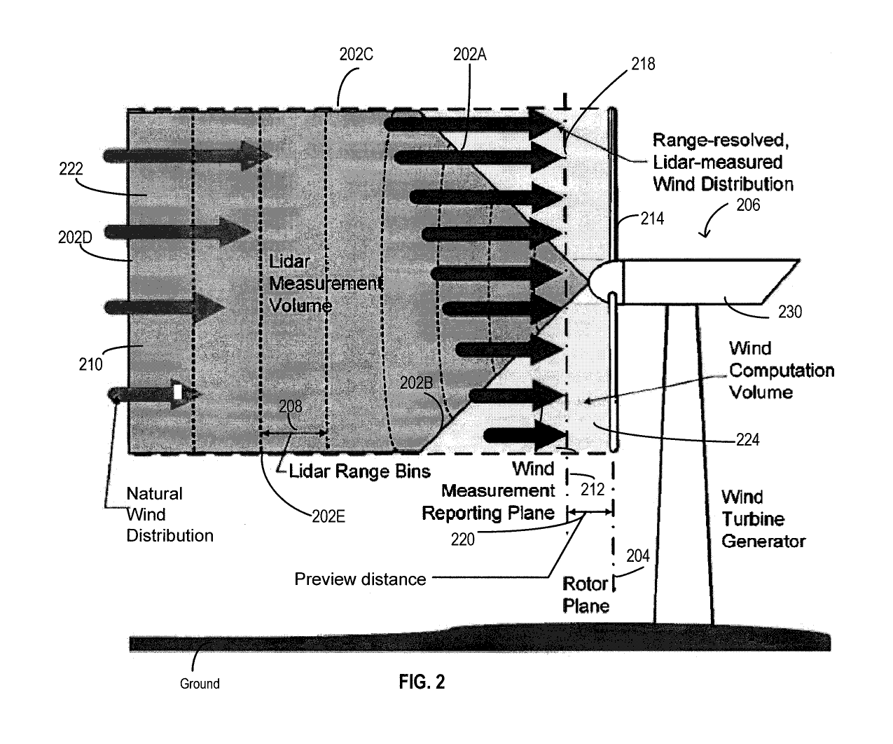

FIG. 2 is a diagram illustrating range-resolved Lidar-measured wind distribution near a wind turbine generator 206 in an embodiment. The wind turbine generator 206 has one, two, three or more rotating blades 214 in a rotor plane 204. Natural wind distribution as pointed by arrows 210 is detected as a function of position, or range from the turbine. Lidar range bin length 208 provides the spatial resolution of a laser radar for wind flow measurements. The natural wind typically has a velocity gradient or a vertical shear above ground. The vertical speed variation may be provided for altitude adjustment for each blade as it rotates from low to high altitude and back to low altitude. Wind measurement reporting plane 212 is defined by a preview distance 220 from the rotor plane 204.

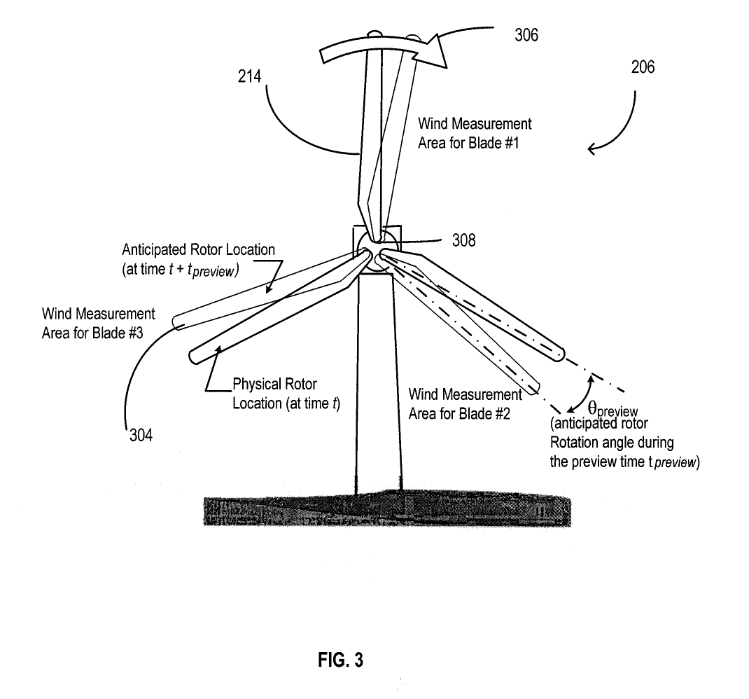

A preview time is calculated based upon preview distance 220 and the local wind speed near the rotor plane 204 for the spatial region slightly ahead of the blade position (see region 304 in FIG. 3). The preview time varies with the turbine type, location and local wind conditions. The preview time may be adjusted for various dimensions of turbines, types of turbines, wind or air dynamics, the operational regime of the turbines, etc.

Generally, wind measurements taken at a greater distance from rotor plane 204, also referred to “long range”, are primarily used for wind-field assessment—turbulence severity monitoring, shear measurements, etc. These ranges are typically greater than the distance for wind measurement to be provided to the control system for the wind turbine generator 206. Although only a small fraction of the wind field interacts with the blades, nacelle, and tower, and thus directly couples to the wind turbine generator (WTG), useful information may be extracted from an entire volumetric field of interest.

Referring to FIG. 2 again, volumetric region 222 is surrounded by lines 202A, 202B, a left portion of line 202C, 202D, and a left portion of line 202E, and is at distance from rotor plane 204. Region 222 is also referred to “long range region”. Lidar measurements are performed in region 222 to produce long range wind data. The data in these long ranges provide important information on gusts, shear and other hazards and give important, advanced, warning of gusts and turbulent conditions.

Moreover, region 224 is surrounded by lines 202A, 202B, a right portion of line 202C and a right portion of line 202E and rotor plane 204 and is also referred as “short range region”. The wind data in short range region 224 contains a preview of on-coming winds and are useful for feed-forward control of the WTG. The wind data in short range region 224 are important for the blade pitch and yaw control systems. Short range region 224 is close enough to wind turbine generator 206 to allow the control system a “feed forward” capability. This feed forward capability is directly tied to the preview time. Long range region 222 and short range region 224 may vary with the average wind speed. For example, the definitions of “long range” and “short range” both increase in distance when the average wind speed increases. The preview distance 220 is primarily determined by the WTG hardware and control algorithms, but can be adjusted due to local wind field conditions and the severity of on-coming gusts.

A laser radar (not shown) may be mounted at several locations near the turbine, such as the nacelle, the hub or the tower. However, the Lidar system can only measure line-of-sight winds along the laser beam in each mounting location. It is increasingly difficult to measure winds that approach right angles across the laser beam, which results in a dead-zone (e.g. short range region 224), i.e. a region where a scanning Lidar system does not measure the local wind field effectively. More specifically, in long range region 222, a single Lidar system can effectively measure the wind field while the single Lidar system cannot effectively measure the wind field in short range region 224. Therefore, propagating wind fields are estimated, based on measured winds in other parts of the wind field, without use of additional Lidar systems for wind measurements. Short range region 224 is also labeled as “Wind Computational Volume” in FIG. 2. This estimation of wind field in short range region 224 is accomplished based on measuring the wind fields in longer range region 222, also labeled as “Lidar Measurement Volume”. The estimation method is based upon several measurements in long range region 222, such as horizontal and vertical shear, spatial structure of the wind field and its temporal characteristics.

The arrival time and severity of the gust or turbulent event are estimated by wind velocity measurements in long range region 222. Such estimations become more accurate as the wind event approaches rotor plane 204. Furthermore, the wind measurements near each blade 214 provide blade-specific wind data, which may be used in conjunction with WTG control algorithms in order to prevent damage to the WTG components, to reduce the loads to the WTG components, to reduce wear and fatigue of the WTG components and to optimize the net electrical power generated by the WTG. It is useful to provide real time wind speed data specific to each blade 214 for gust alleviation and blade pitch control. It is also useful to provide feed-forward and preview wind data to the WTG control algorithms. The wind data provide both wind velocity vector measurements including speed and direction and the associated arrival time when a wind event can be expected to impact a blade. For example, the wind data provides wind velocity at a specific impact time, such as the preview time associated with the feed-forward control algorithm. Range-resolved wind profiles are provided at each scan position to improve the spatial resolution of the measured wind field and increase the temporal speed of the data update rate. The wind field or data in long range region 222 are used to quantify the severity of gusts, shear and turbulence and to provide accurate estimates of the wind field in short range region 224, which is a portion of the wind field that can be acted upon by the WTG control algorithms.

In an alternative embodiment, the blade-specific wind fields may be calculated based upon the wind data measured in long range region 222, which can reduce the cost for using multiple laser radars for providing blade-specific wind data.

In an alternative embodiment, wind profile scaling vectors may be applied to report the range-resolved wind data in order to reduce the volume of data transferred to the WTG control algorithm. For example, a rotor-diameter scaling factor may be applied to the range-resolved wind data to calculate the impact of a specific wind parcel on a specific location of blade 214. The aerodynamic collection efficiency of each blade and specific blade types, along the blade diameter, may be applied to the range-resolved wind data. Both blade-loading and rotor torque impact may be calculated using such scaling vectors.

FIG. 3 is a diagram illustrating blade-specific wind monitoring for preview wind measurements in an embodiment. FIG. 3 shows an anticipated rotor rotation in a preview time. A preview angle is an angle between the position of each blade 214 or rotor at time t and the anticipated position at a time t+t_{preview}, as illustrated in FIG. 3. A rate of blade rotation determines the blade position at the end of the feed-forward duration, or the preview time. The preview time is calculated based upon preview distance 220 and the local wind velocity in spatial region 304 ahead of the position of each blade 214. Wind measurement areas 304 for each blade are the areas blades 214 will rotate to in a direction pointed by arrow 306. The wind measurement areas 304 for each blade 214 are a portion of short range region 224 as illustrated in FIG. 2. For clarity, long range region 222 is not shown in FIG. 3

Wind turbine generator (WTG) 206 does not react to all spatial and temporal scales equally. For example, large spatial scale wind fields are much larger than the rotor diameter or blade diameter and may appear to be laminar to WTG 206 and couple efficiently to WTG 206. On the other hand, small spatial scale wind fields are much smaller than the rotor diameter and are not energetic enough to significantly affect the WTG blades or tower. Likewise, large temporal scales appear as slowly-varying wind conditions, such that long-term temporal wind fields can be effectively managed with WTG control algorithms. However, very quickly varying temporal scales do not energetically couple to WTG 206. Thus, the impact of the wind fields on a wind turbine depends on the spatial and temporal scales of the wind fields, the turbine type and size, the rotor type and size, and the local wind speed. The Lidar measurement range, preview time, and preview angle are critical to the performance of WTG 206. Such values need to be determined depending on, among others, the size of the turbine rotors, local wind conditions, currently-encountered wind speeds, levels of local turbulence and shear, and desired blade pitch rates for reduction in wear and fatigue of blade-pitch actuation components.

WTG 206 includes three operating regimes. A first Regime is for wind speeds below a minimum wind speed. A second Regime is for wind speeds above the minimum speed, but less than a threshold for power generation. A third Regime is for wind speeds at or above the threshold for power generation, but below a maximum safe operating wind speed. WTG 206 may process the range-resolved wind data differently, depending on the three operating regimes of WTG 20.

In a specific embodiment, sensor 308 is mounted in a turbine hub (not shown). A measurement optical axis is co-linear with turbine shaft 230 (see FIG. 2) such that the wind measurement coordinate is aligned to the wind vectors that have the greatest impact on blades 206. Single-angle conic, multi-angle conic and rosette scans may be economically generated to provide range-resolved wind measurements with small spatial resolution by using robust and cost-effective hardware.

In an alternative embodiment, the mounting location of the laser radar may vary, such as nacelle-mounting, turbine tower mounting and ground based mounting. The Lidar system may simultaneously provide wind velocity, temperature and pressure measurements, such as Rayleigh/Mie Lidar. Such Lidar system may provide range resolved wind profiles, temperature, and pressure. Such Lidar systems may also provide local Richardson Number and/or Reynolds Number information.

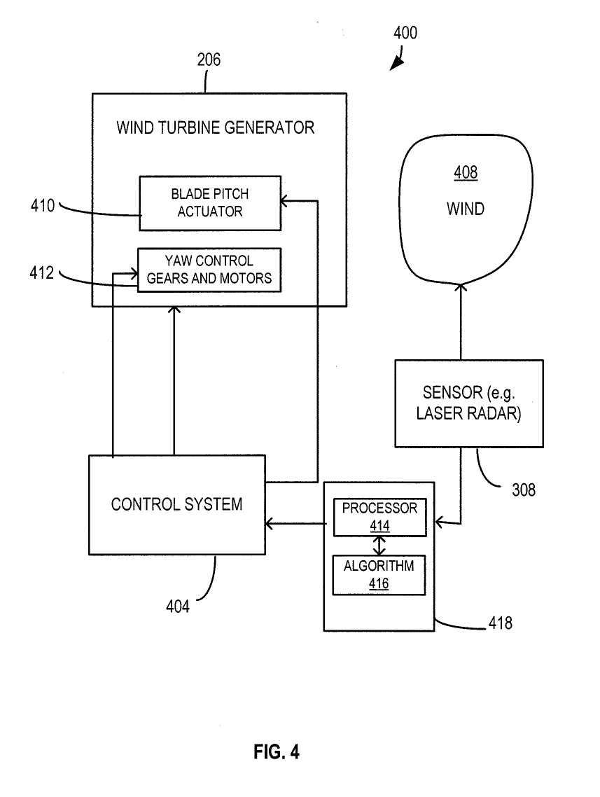

FIG. 4 is a simplified system diagram in an embodiment. System 400 includes a wind turbine generator 206, which has yaw control gears and motors or yaw angle actuator 412 and blade pitch actuator 410. System 400 also includes a sensor 308 for monitoring wind field 408 near the wind turbine generator 206. System 400 further includes a control system 404 for controlling blade pitch actuator 410 and yaw control gears and motors 412 among other functions. System 400 also includes a computer system 418 with a processor 414 for analyzing the wind data from the sensor 308 with an algorithm 416. Computer system with processor 414 provides range-resolved wind data, which include wind data or wind fields in short range region 224 and long range region 222 of FIG. 2 as well as blade-specific wind data or wind fields, to control system 404.

Sensor 308 may be a Lidar capable of providing various measurements, including wind velocity measurements, temperature measurements, and/or pressure measurements. Sensor 308 is coupled to processor 414 which is coupled to control system 404.

Control system 404 is operably coupled to wind turbine generator 206 for yaw control, blade pitch control and gust alleviation based upon the data analysis performed in processor 414 using the wind data measured with sensor 308, such as a Lidar. Control system 404 is also coupled to yaw control gears and motors 412. Control system 404 may also be coupled to other input sensors (not shown) to receive information on feed-back control torque, tower strain, electric generator rotor speed and electric generator load. Control system 404 may include feedback control of load, rotor speed, and electrical power generation of wind turbine generator 206.

Sensor 308 needs to be capable of monitoring an entire field of interest, which at least includes a cylindrical spatial volume defined by the area swept by the rotors or blades 214 over a length up-wind of the turbine, such as long range region 222 in FIG. 2, sufficient for gust detection and alleviation. The wind fields in the spatial volume need to be monitored with sufficient spatial resolution in order to monitor moderate-scale wind field events. The spatial resolution needs to be equal or smaller than approximately one-third of the rotor diameter. Preferably, the spatial resolution is one-tenth (or smaller) of the rotor diameter.

Sensor 308 also needs to be capable of monitoring the entire volumetric field with a sufficiently high sampling rate to capture the wind fields that couple efficiently to the WTG. To reduce power consumption, bulk, cost, wear and fatigue for blade pitch actuators 410 and yaw control gears and motors 412, a reaction time for control system 404 is typically limited to the order of approximately 1 second. Therefore, a minimum response time for the sensor is about one-third of a second, which provides a data update rate of at least 3 Hz. Faster update rates are preferred, especially during energetic gust events. If sensor or Lidar 308 fails, WTG 206 does not fail, but will lose “feed forward” capability. Control system 404 may then operate in a reduced-capability mode that does not produce maximum efficiency for energy generation or approach higher blade loading levels.

WTG 206 may need to feather the blades for significant gusts. However, the maximum pitch rate is set by the blade pitch hardware. To increase the reliability and reduce fatigue, WTG 206 prefers to utilize slower blade pitch rates.

It is desirable to combine available wind measurements and techniques to provide the most accurate wind field assessments and arrival time predictions. More specifically, range-resolved wind data may be obtained by combining measured wind data in long range region 222 for wind field assessments and calculated wind data in short range region 224 near rotor plane 204 as well as calculated or measured blade-specific wind data. The range-resolved wind data in short range region 224 may be used by algorithms for gust alleviation and blade pitch control and yaw control.

Moreover, different spatial and temporal processing techniques may be used. Since the wind data are collected over the long range in real time, Taylor's “frozen turbulence” assumption may be used to cover those spatial regions not directly measured by the Lidar scan pattern, such as short range region. Additionally, higher order temporal and spatial terms can be calculated to more accurately quantify flow field disturbances such as shear, turbulence, and gusts, especially near the rotor plane.

According to embodiments of the present disclosure, systems and methods are provided to monitor, classify, assess and detect on-coming wind conditions and hazards for modern wind turbines. The methods include monitoring the on-coming flow field with sufficient speed and spatial resolution for gust alleviation and blade-pitch control and yaw control of modern wind turbines. The methods also include performing data analyses at sufficient speeds, and at appropriate spatial locations.

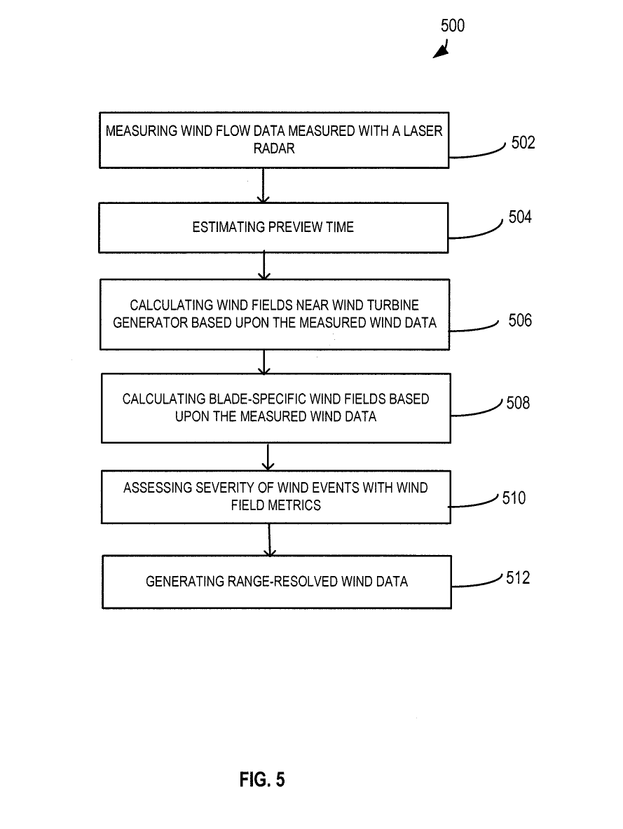

FIG. 5 is a flow chart 500 illustrating steps for generating range-resolved wind data near a wind turbine generator. The method 500 starts with measuring wind data in long range region 222 measured with a laser radar 308 mounted on, or near, wind turbine generator 206 at step 502. The long range region is at a distance from a rotor plane of the wind turbine generator. The method 500 includes estimating preview time at step 504. The method 500 also includes step 506 of calculating wind fields in short range region 224 closer to the rotor plane of the wind turbine generator 206 based upon measured wind data in long range region 222. The method 500 also includes step 508 of calculating blade-specific wind field based upon measured wind data in long range region 222. The method also includes step 510 of assessing severity of wind events with wind field metrics. The method 500 further includes step 512 of generating the range-resolved wind data.

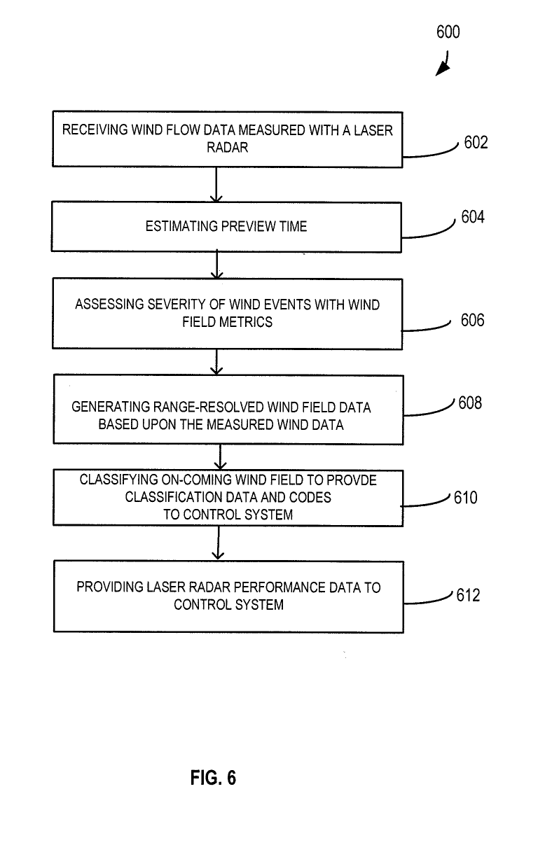

FIG. 6 is a flow chart 600 for illustrating steps for providing classification data and code to a control system coupled to a wind turbine generator. The method 600 starts with receiving range-resolved wind data at step 602 in a computer system with a processor 414. The method 600 includes estimating preview time at step 604. The method 600 also includes step 606 of assessing severity of wind events with wind field metrics. The method 600 further includes step 608 of generating the range-resolved wind data. The method also includes classifying on-coming wind field to provide classification data and codes to a control system at step 610. The method may also include Laser Radar performance data to the control system at step 612.

Control system 404 uses the wind data in short range region 224 for adjusting blade pitch and yaw control to wind turbine generator 206 at step 506. Processor 414 also assesses severity of wind events with wind field metrics to provide the metrics to control system 404 at step 508. Processor 414 further classifies on-coming flow field to provide classification data and codes to control system 404 at step 510 and provide Lidar performance data to control system at step 512.

Numerous scanning methods can be used to monitor and/or assess the entire volumetric field of interest or sub-sets of the entire volumetric field of interest. The scanning methods include azimuth scans and/or elevation scans, and/or a combination of azimuth and elevation scans from raster pattern scanners. Additionally, conic scans include a singular conic angle or multiple conic angles, and rosette scans performed by Risely prism scanners. Other scanning systems that may be used include, Micro-Opto-Electric Machine (MEMS) scanners, and scanning systems incorporating Holographic Optical Elements (HOEs), Diffractive Optical Elements (DOEs), and wedge prisms, etc.

Wind data may be reported in numerous coordinate systems, allowing differing WTG control algorithms or data reporting systems to address different operational issues. The coordinate systems may be an Earth-centered system based on local geospatial coordinates, or turbine-centered system based on a reference located on the turbine, i.e. at the intersection of the turbine rotor shaft and the rotor plane. Numerous methods and metrics can be used to detect, monitor and assess the wind field.

Wind field data products include wind field metrics, classification data and codes and Lidar-specific performance data. By using the wind field metrics, wind fields in short range region 224 and blade specific data are estimated by using measured wind flow data in long range region 222 from a single Lidar 308. The wind field metrics include the following:
(1) A velocity of a wind parcel, such as a sector to be encountered by a turbine blade, and an associated arrival time of the wind parcel to impact the blade,
(2) The range-resolved wind velocity profile, including a maximum wind speed,
(3) A first moment of the range-resolved velocity measurement (i.e., the average wind),
(4) A second moment of the range-resolved velocity measurement (i.e., the standard deviation, or Lidar spectral width, of the measured wind profile),
(5) An eddy dissipation rate, calculated or estimated from the wind field parameters,
(6) A velocity structure function average ([v(r+Δr)−v(r)]²), where v(r) is the wind velocity measured at range r, and Δr is the local spatial resolution, or an alternate form of the velocity structure function average ([(v(r+Δr)−v(r))/Δr]²),
(7) A velocity gradient ∇v(r), or a magnitude of the velocity gradient |∇v(r)| or (∇v(r))², and ensemble averages of these gradient-based metrics,
(8) Atmospheric stability metrics based on measured temperature profiles, such as the temperature gradient ∇T(r), where T(r) is the measured temperature profile, or the Richardson Number, Ri,
(9) Atmospheric flow regime metrics based on localized velocity, temperature and pressure measurements, such as Reynolds Number, and
(10) Rotor weighting function or vector V(r) which compensates for the impact of the wind parcel on the blade.

The wind field metrics may be evaluated in Earth-centered (x, y, z) coordinates, or spherical coordinates (ρ, θ, φ), cylindrical coordinates (φ, r, l) or along blade-specific directions (r, φ). The wind field metrics may be calculated for those sub-sections of the wind field that ultimately impact the blades. The wind field metrics may be multiplied by, or compensated with the rotor weighing function. For example, weighting functions or vectors may be applied to the range-resolved wind data to calculate the effective blade loading and/or the torque delivered to each blade. In Earth-centered, turbine-centered or blade-specific coordinate systems, and over all portions, or sub-portions, of the volumetric field of interest, wind field metrics may be used to detect, monitor and assess the wind field. For example, these wind field metrics may be modified to correct for diameter-dependent rotor performance or to correct for Lidar performance, such as Lidar signal level or Lidar signal-to-noise ratio (SNR). The wind field metrics can be used to assess the type, severity and impact of the wind field. Such wind field metrics provide wind field classifications to assist the WTG 206 to select among various control algorithms and methods.

The classification data and codes may be developed and delivered to the WTG for control purposes. The classification data and codes include the following:
(1) type and severity of the range-resolved wind field, including horizontal, vertical, blade-wise shear, and blade-to-blade shear data,
(2) loading and/or variability on each blade resulting from the blade-specific wind field,
(3) rotor torque and/or variability delivered by each blade resulting from the blade-specific wind field,
(4) severity, arrival time, and spatial characteristics for gusts,
(5) A temporal characteristics of the range-resolved wind field, such as arrival times for on-coming gusts, hazards or flow variations, and
(6) A spatial characteristics of the range-resolvedwind field, such as wind field variability as a function of yaw direction or blade position.

Wind field data products may include any of the above-mentioned metrics and classification data/codes. In addition, Lidar-specific performance data may be included.

The Lidar-specific performance data include (1) data validity that includes 0 and 1 for data determined to be invalid and valid respectively, (2) Lidar hardware and software operating status codes, including failure codes from Built-in-Test results, (3) Lidar maintenance codes, such as dirty window or insufficient power supply, and (4) Lidar performance characteristics, such as signal strength or signal-to-noise ratio (SNR), Lidar sensitivity degradation due to weather such as snow and rain.

The methods and system provide a low cost alternative to wind measurement systems having multiple Lidars. Wind data in long range region can be measured with a single Lidar. Wind data in short range region can be calculated based upon the wind data measured in the long range. The range-resolved wind data, which includes the wind data in both long range region and short range region as well as blade-specific wind data, help the wind turbine generators perform effective gust alleviation, blade pitch control and yaw control to reduce structural fatigue and damage, to protect expensive turbines from severe but brief and fast moving wind events and to improve reliability and to enhance energy capture efficiency.

Having described several embodiments, it will be recognized by those skilled in the art that various modifications, alternative constructions and equivalents may be used without departing from the spirit of the disclosure, for example, variations in sequence of steps and configuration, etc. Additionally, a number of well known mathematical derivations and expressions, processes and elements have not been described in order to avoid unnecessarily obscuring the present disclosure. Accordingly, the above description should not be taken as limiting the scope of the disclosure.

It should thus be noted that the matter contained in the above description or shown in the accompanying drawings should be interpreted as illustrative and not in a limiting sense. The following claims are intended to cover generic and specific features described herein, as well as all statements of the scope of the present method and system.

What is claimed is:

1. A method for generating range-resolved wind data near a wind turbine generator coupled to a control system, comprising:
measuring wind flow data in a first long range region at a distance from a rotor plane of the wind turbine generator with a laser radar;
calculating wind fields in a second short range region and blade-specific wind fields for the at least one rotating blade based upon the measured wind flow data, the second short range region being generally closer to the rotor plane of the wind turbine generator than the first long range region; and
generating range-resolved wind data.

2. The method of claim 1, wherein the range-resolved wind data comprise the wind flow data measured in the first long range region, the wind fields in the second short range region and blade-specific wind fields calculated based upon the wind data measured in the first long range region.

3. The method of claim 1, further comprising estimating a preview time.

4. The method of claim 1, the step of generating range resolved wind data comprising reporting the range-resolved wind data in a coordinate system selected from a group consisting of an Earth-centered coordinate system, a spherical coordinate system, a cylindrical coordinate system, a blade-specific coordinate system, and a turbine-centered coordinate system.

5. The method of claim 1, the step of generating range resolved wind data comprising applying wind profile scaling vectors to the range-resolved wind data.

6. The method of claim 1, further comprising assessing wind flow severity with one or more metrics.

7. The method of claim 1, the step of calculating wind fields comprising calculating the wind fields in the second short range region and the blade-specific wind fields by using one or more metric selected from a group consisting of
(1) A velocity of a wind parcel comprising a sector to be encountered by the blade and an associated arrival time of the wind parcel to impact the blade,
(2) The range-resolved wind data including a maximum wind speed,
(3) A first moment of the range-resolved wind data or average wind velocity,
(4) A second moment of the range-resolved wind data comprising standard deviation in wind velocity and Lidar spectral width of the measured wind flow data,
(5) An eddy dissipation rate calculated or estimated from the wind flow data,
(6) A velocity structure function average ([v(r+Δr)−v(r)]²), wherein v(r) is the wind velocity measured at range r, and Δr is the local spatial resolution, or the velocity structure function average ([(v(r+Δr)−v(r))/Δr]²),
(7) A velocity gradient ∇v(r), or a magnitude of the velocity gradient |∇v(r)| or (∇v(r))², and averages of the velocity gradient or the magnitude of the velocity gradient,
(8) Atmospheric stability metrics based on measured temperature profiles T(r) and temperature gradient ∇T(r), the atmospheric stability metrics comprising Richardson Number, Ri,
(9) Atmospheric flow regime metrics based on localized velocity, temperature and pressure measurements, the atmospheric flow regime metrics comprising Reynolds Number, and
(10) Rotor weighting function or vector V(r) for compensating the impact of the wind parcel on the blade.

8. The method of claim 1, further comprising classifying the range-resolved wind data to provide classification codes to the control system.

9. The method of claim 8, wherein the classification codes are dependent upon operating regime(s) for the wind turbine generator, wherein the operating regime is selected from a group consisting of a first regime for wind speeds below a minimum wind speed, a second regime for wind speeds above the minimum speed, but less than a threshold for power generation, and a third regime for wind speeds at or above the threshold for power generation, but below a maximum safe operating wind speed.

10. The method of claim 8, further comprising reporting classification data and codes to the control system for enhanced control of the wind turbine generator, wherein the classification data and codes comprise:
(1) type and severity of the range-resolved wind data including horizontal, vertical, blade-wise shear, and blade-to-blade shear data,
(2) loading and/or variability on each blade resulting from the blade-specific wind fields,
(3) rotor torque and/or variability delivered by each blade resulting from the blade-specific wind fields,
(4) severity, arrival time, and spatial characteristics for gusts,
(5) A temporal characteristics of the range-resolved wind data, the temporal characteristics comprising arrival times for on-coming gusts, hazards or flow variations, or
(6) A spatial characteristics of the range-resolved wind fields, the spatial characteristics comprising wind fields variability as a function of the yaw angle or the position of the blade.

11. The method of claim 1, further comprising providing performance data codes to the control system, wherein the performance data codes comprise data validity codes, laser radar operating status codes, laser radar maintenance codes, or laser radar performance codes.

12. The method of claim 1, wherein the wind flow data measured in the first long range region have a spatial resolution equal to or less than one-third of the blade diameter.

13. The method of claim 1, wherein the wind flow data measured in the first long range region have a spatial resolution equal or less than one-tenth of the blade diameter.

14. A system for generating range-resolved wind data near a wind turbine generator, the system comprising:
a laser radar mounted on the wind turbine generator for measuring wind fields in a first long range region at a distance from a rotor plane of the wind turbine generator; and
a computer system to receive the wind fields in a first long range region and to generate range-resolved wind data with an algorithm.

15. The system of claim 14, wherein the range-resolved wind data comprise the wind fields measured in the first long range region, wind fields in a second short range region and blade-specific wind fields calculated based upon the wind fields measured in the first long range region, the second short range region being generally closer to the rotor plane of the wind turbine generator than the first long range region.

16. The system of claim 15, wherein the algorithm comprises executable instructions to calculate the wind fields in the second short range region and blade-specific wind fields by using a metric selected from a group consisting of
(1) A velocity of a wind parcel comprising a sector to be encountered by the blade and an associated arrival time of the wind parcel to impact the blade,
(2) The range-resolved wind data comprising a maximum wind speed,
(3) A first moment of the range-resolved wind data or average wind velocity,
(4) A second moment of the range-resolved wind data comprising standard deviation in wind velocity and Lidar spectral width of the measured wind flow data,
(5) An eddy dissipation rate calculated or estimated from the measured wind fields,
(6) A velocity structure function average ([v(r+Δr)−v(r)]²), wherein v(r) is the wind velocity measured at range r, and Δr is the local spatial resolution, or the velocity structure function average ([(v(r+Δr)−v(r))/Δr]²),
(7) A velocity gradient ∇v(r), or a magnitude of the velocity gradient |∇v(r)| or (∇v(r))², and averages of the velocity gradient or the magnitude of the velocity gradient,
(8) Atmospheric stability metrics based on measured temperature profiles T(r) and temperature gradient ∇T(r), the atmospheric stability metrics comprising Richardson Number, Ri,
(9) Atmospheric flow regime metrics based on localized velocity, temperature and pressure measurements, the atmospheric flow regime metrics comprising Reynolds Number, and
(10) Rotor weighting function or vector V(r) for compensating the impact of the wind parcel on the blade.

17. The system of claim 14, wherein the algorithm comprises executable instructions to generate classification data and codes based upon the range-resolved wind data, wherein the classification data and codes comprise:
(1) type and severity of the range-resolved wind data including horizontal, vertical, blade-wise shear, and blade-to-blade shear data,
(2) loading and/or variability on each blade of the wind turbine generator resulting from the blade-specific wind fields,
(3) rotor torque and/or variability delivered by each blade resulting from the blade-specific wind fields,
(4) severity, arrival time, and spatial characteristics for gusts,
(5) A temporal characteristics of the range-resolved wind fields, the temporal characteristics comprising arrival times for on-coming gusts, hazards or flow variations, and
(6) A spatial characteristics of the range-resolved wind fields, the spatial characteristics comprising wind fields variability as a function of the yaw angle or the position of the blade.

18. The system of claim 17, further comprising a control system coupled to the computer system for receiving the wind classification data and codes for adjusting the wind turbine generator based upon the wind classification data and codes.

19. The system of claim 18, wherein the control system has a reaction time equal to or less than approximately 1 second.

20. The system of claim 18, wherein the control system has a data update rate of at least approximately 3 Hz.

21. The system of claim 18, wherein the wind turbine generator comprises at least one rotating blade, a blade pitch actuator, and a yaw angle actuator, each coupled to the control system.

22. The system of claim 14, wherein the algorithm comprises executable instructions to provide performance data codes to a control system coupled to the wind turbine generator, wherein the performance data codes comprise data validity codes, laser radar operating status codes, laser radar maintenance codes, or laser radar performance codes.

23. The system of claim 14, wherein the laser radar is mounted on a location near the wind turbine generator, the location selected from a group consisting of turbine hub, nacelle, turbine tower, and ground.

24. The system of claim 14, wherein the laser radar has a response time of equal to or less than ⅓ second.

25. A non-transitory computer readable storage medium for generating range-resolved wind data near a wind turbine generator, comprising executable instructions to:
calculate wind fields and blade-specific wind fields in a short range region close to a rotor plane of the wind turbine generator based upon wind flow data measured in a long range region at a further distance from the rotor plane of the wind turbine generator; and
generate range-resolved wind data.

26. The non-transitory computer readable storage medium of claim 25, further comprising executable instructions to calculate the wind fields by using a metric selected from a group consisting of
(1) A velocity of a wind parcel comprising a sector to be encountered by the blade and an associated arrival time of the wind parcel to impact the blade,
(2) The range-resolved wind data comprising a maximum wind speed,
(3) A first moment of the range-resolved wind data or average wind velocity,
(4) A second moment of the range-resolved wind data comprising standard deviation in wind velocity and Lidar spectral width of the measured wind flow data,
(5) An eddy dissipation rate calculated or estimated from the wind flow data,
(6) A velocity structure function average ([v(r+Δr)−v(r)]²), wherein v(r) is the wind velocity measured at range r, and Δr is the local spatial resolution, or the velocity structure function average ([(v(r+Δr)−v(r))/Δr]²),
(7) A velocity gradient ∇v(r), or a magnitude of the velocity gradient |∇v(r)| or (∇v(r))², and averages of the velocity gradient or the magnitude of the velocity gradient,
(8) Atmospheric stability metrics based on measured temperature profiles T(r) and temperature gradient ∇T(r), the atmospheric stability metrics comprising Richardson Number, Ri,
(9) Atmospheric flow regime metrics based on localized velocity, temperature and pressure measurements, the atmospheric flow regime metrics comprising Reynolds Number, and
(10) Rotor weighting function or vector V(r) for compensating the impact of the wind parcel on the blade.

27. The non-transitory computer readable storage medium of claim 25, wherein the range-resolved wind data comprise the wind flow data measured in the long range region, the wind fields in the short range region, and the blade-specific wind fields.

28. A non-transitory computer readable storage medium for providing wind classification codes to a control system coupled to a wind turbine generator, comprising executable instructions to generate classification data and codes based upon range-resolved wind fields, wherein the classification data and codes comprise one or more of the following:
(1) type and severity of the range-resolved wind fields including horizontal, vertical, blade-wise shear, and blade-to-blade shear data,
(2) loading and/or variability on each blade of the wind turbine generator resulting from the blade-specific wind fields,
(3) rotor torque and/or variability delivered by each blade resulting from the blade-specific wind fields,
(4) severity, arrival time, and spatial characteristics for gusts,
(5) A temporal characteristics of the range-resolved wind fields, the temporal characteristics comprising arrival times for on-coming gusts, hazards or flow variations, and
(6) A spatial characteristics of the range-resolved wind fields, the spatial characteristics comprising wind fields variability as a function of the yaw angle or the position of the blade.

29. The non-transitory computer readable storage medium of claim 28, wherein the range-resolved wind fields comprise wind flow data measured in a first long range region at a distance from a rotor plane of the wind turbine generator, wind fields in a second short range region and blade-specific wind fields calculated based upon the wind data measured in the first long range region, the second short range region being generally closer to the rotor plane of the wind turbine generator than the first long range region.

30. The non-transitory computer readable storage medium of claim 29, further comprising executable instructions to calculate the wind fields in the second short range region and blade-specific wind fields based upon the wind flow data measured in the first long range region by using one or more metric selected from a group consisting of
(1) A velocity of a wind parcel comprising a sector to be encountered by the blade and an associated arrival time of the wind parcel to impact the blade,
(2) The range-resolved wind data comprising the maximum wind speed,
(3) A first moment of the range-resolved wind data or average wind velocity,
(4) A second moment of the range-resolved wind data comprising standard deviation in wind velocity and Lidar spectral width of the measured wind flow data,
(5) An eddy dissipation rate calculated or estimated from the wind flow data,
(6) A velocity structure function average ([v(r+Δr)−v(r)]²), wherein v(r) is the wind velocity measured at range r, and Δr is the local spatial resolution, or the velocity structure function average ([(v(r+Δr)−v(r))/Δr]²),
(7) A velocity gradient ∇v(r), or a magnitude of the velocity gradient |∇v(r)| or (∇v(r))², and averages of the velocity gradient or the magnitude of the velocity gradient,
(8) Atmospheric stability metrics based on measured temperature profiles T(r) and temperature gradient ∇T(r), the atmospheric stability metrics comprising Richardson Number, Ri,
(9) Atmospheric flow regime metrics based on localized velocity, temperature and pressure measurements, the atmospheric flow regime metrics comprising Reynolds Number, and
(10) Rotor weighting function or vector V(r) for compensating the impact of the wind parcel on the blade.

31. The non-transitory computer readable storage medium of claim 28, further comprising executable instructions to provide performance data codes to the control system, wherein the performance data codes comprise data validity codes, laser radar operating status codes, laser radar maintenance codes, or laser radar performance codes.
